(19) United States
(12) Patent Application Publication
(10) Pub. No.: US 2021/0392726 A1
(43) Pub. Date: Dec. 16, 2021

(54) LED LIGHT WITH DIMMING FUNCTION

(71) Applicant: SHENZHEN TOPBAND CO., LTD., Shenzhen (CN)

(72) Inventors: Qinghua Yang, Shenzhen (CN); Yulong Wu, Shenzhen (CN)

(21) Appl. No.: 17/033,915

(22) Filed: Sep. 27, 2020

(30) Foreign Application Priority Data
Jun. 12, 2020 (CN) 202010537393.5

(51) Int. Cl. H05B 45/14

(52) U.S. Cl. CPC H05B 45/14

(57) ABSTRACT

The present disclosure relates to a LED light with dimming function, including: a LED light body; a dimming assembly, a control device, and an output unit. The dimming assembly is arranged on the LED light body and adjusts a resistance thereof according to an adjusting signal and/or an operation. The control device is arranged in the LED light body and is electrically connected with the dimming assembly; the control device detects the resistance of the dimming assembly and adjusts an output current according to the resistance of the dimming assembly. The output unit is connected with the control device, receives the output current, and sends the output current to the LED light.

### CROSS REFERENCE TO RELATED APPLICATIONS

The present application claims the benefit of Chinese Patent Application No. 202010537393.5 filed on Jun. 12, 2020, the contents of which are incorporated herein by reference in their entirety.

### TECHNICAL FIELD

The present disclosure generally relates to light technologies, and particularly, to a LED light with dimming function.

### BACKGROUND

LED lights on the market (such as LED tubes, LED panels) cannot be connected with external light adjustment wires through wires. The existing dimming methods mainly include: 0-10V or 1-10V dimming method, thyristor dimming method, PWM dimming method, etc. In these dimming methods, a chip of the LED light is required to have dimming function, and the LED light need to match the corresponding dimmer or gateway, sensor, remote control, or use an external power source. On the one hand, these dimming methods are limited by the chip since the chip is required to have dimming function, on the other hand, it is expensive and inconvenient to use. Based on the requirements of DLC5.1 for LED lights, LED lights must have dimming function. Except the thyristor dimming method, the existing LED lights cannot realize light dimming.

### SUMMARY OF THE DISCLOSURE

Therefore, the present disclosure aims to provide a LED light with dimming function to solve the problem of the present LED lights mentioned above.

For solving the above problem, a LED light with dimming function is provided, including: a LED light body, a dimming assembly, a control device, and an output unit. The dimming assembly is arranged on the LED light body and adjusts a resistance thereof according to an adjusting signal and/or an operation. The control device is arranged in the LED light body and is electrically connected with the dimming assembly; the control device detects the resistance of the dimming assembly and adjusts an output current according to the resistance of the dimming assembly. The output unit is connected with the control device, receives the output current, and sends the output current to the LED light.

In an embodiment, the dimming assembly includes a resistor and/or an adjusting device connected with the resistor; the adjusting device adjusts a resistance of the resistor according to the adjusting signal from a user, thereby adjusting the resistance of the dimming assembly.

In an embodiment, the resistor includes a variable resistor or a fixed resistor.

In an embodiment, the adjusting device includes one or more selected from a group consisting of a sliding knob, a gear knob, a sliding push button, a gear push button, a dial push button, and a pressed push button.

In an embodiment, the LED light body includes a lamp tube body, and the adjusting device is arranged on the lamp tube body.

In an embodiment, the LED light body includes a first end cover and a second end cover arranged on two ends of the lamp tube body, and the adjusting device is arranged on the first end cover and/or the second end cover.

In an embodiment, the dimming assembly includes a sensing unit which is arranged on the LED light body for sensing environmental information surrounding the LED light and adjusting a resistance thereof according to the environmental information.

In an embodiment, the sensing unit includes one or more selected from the group consisting of a thermistor, a photosensitive resistor, an acoustic sensitive resistor, a force sensitive resistor, a gas sensitive resistor, a humidity sensitive resistor, and a magnetic resistor.

In an embodiment, the control device includes a control IC, a detecting end of the control IC is connected with the variable resistor, an output end of the control IC is connected with the output unit; and/or a detecting end of the control IC is connected with the sensing unit, and an output end of the control IC is connected with the output unit.

In an embodiment, the LED light with dimming function further includes an input filtering circuit, wherein the input filtering circuit is arranged between a voltage signal input end of the LED light and the control device for receiving a voltage signal inputted by an input end, filtering the voltage signal, and sending the filtered voltage signal to the control device.

The LED light with dimming assembly has the following beneficial effects. The LED light includes the LED light body, the dimming assembly, the control device, and the output unit. The dimming assembly is arranged on the LED light body and adjusts a resistance thereof according to an adjusting signal and/or an operation. The control device is arranged in the LED light body and is electrically connected with the dimming assembly, detects the resistance of the dimming assembly, and adjusts the output current according to the resistance of the dimming assembly. The output unit is connected with the control device, receives the output current, and sends the output current to the LED light. The LED light can realize the dimming function without requiring the IC to have the dimming function, without using a dimmer, a gateway, a sensor, and a controller, thus, the LED light has a simple dimming function and a low cost and is convenient to use.

### BRIEF DESCRIPTION OF THE DRAWINGS

The present disclosure will be described in more detail with reference to the accompany drawings and the embodiments, wherein in the drawings:

FIG. 1 is a schematic view of a LED light with dimming function in accordance with an embodiment of the present disclosure;

FIG. 2 is a partial circuit diagram of the LED light in accordance with an embodiment of the present disclosure;

FIG. 3 is a partial circuit diagram of the LED light in accordance with another embodiment of the present disclosure;

FIG. 4 is a partial circuit diagram of the LED light in accordance with yet another embodiment of the present disclosure; and

FIGS. 5 to 18 are views showing arrangements of a dimming assembly of different embodiments.

### PREFERRED EMBODIMENTS

For clearly understanding technical features, purpose, and effect of the present disclosure, embodiments are given in detail hereinafter with reference to the accompanying drawings.

It should be noted that if there is no special description, when a feature is “fixed” or “connected” to another feature, the feature can be directly or indirectly fixed or connected to another feature. In addition, the description of upper, lower, left, right, front and rear in the present disclosure are used relative to the mutual position relationship of the components in the attached drawings. Furthermore, unless otherwise defined, all technical and scientific terms used herein have the same meanings as those commonly understood by one having ordinary skill in the art. The terms used in the specification herein are intended to illustrate the embodiments instead of to limit the invention. The terms “and/or” as used herein include any combination of one or more related listed items.

For satisfying the requirements for LED lights set in the new standard DLC5.1, the present disclosure provides a LED light with dimming function. The LED light is provided with dimming function for adjusting light level. The LED light can quickly and simply adjust the light level without requiring an IC to have the dimming function and without using external dimming tools like dimmers, gateways, sensors, or controllers. Also, the dimming function of the LED light does not need to be realized outside the power supply. In some embodiments, the LED light can be one in any form (such as shape and size) including but not limited to a lamp tube body 11, a LED cover, a LED light plate.

In an embodiment, the LED light includes a LED light body 10, a dimming assembly 40, a control device 30, and an output unit 50. The dimming assembly 40 is arranged on the LED light body 10 and is capable of adjusting a resistance thereof according to an adjusting signal. The control device 30 is arranged on the LED light body 10 and is electrically connected with the dimming assembly 40. The control device 30 detects the resistance of the dimming assembly 40 and adjusts an output current according to the resistance of the dimming assembly 40. The output unit 50 is connected with the control device 30, receives the output current and sends the output current to the LED light.

In some embodiments, the dimming assembly 40 is used for adjusting the resistance thereof according to the adjusting signal and/or an operation, for example, increasing or decreasing the resistance thereof. The control device 30 is electrically connected with the dimming assembly 40 for detecting the resistance of the dimming assembly 40 and adjusting the output current according to the resistance of the dimming assembly 40, thereby adjusting the level of the LED light.

In some embodiments, the dimming assembly 40 may include a resistor. The resistor can be a variable resistor or a fixed resistor. In some embodiments, the dimming assembly 40 may include the adjusting device 41. The adjusting device 41 can be a potentiometer and a resistance thereof can be adjusted according to an operation of a user such that the resistance of the dimming assembly 40 can be adjusted. In some embodiments, the dimming assembly 40 may include a variable resistor and the adjusting device 41 connected with the variable resistor. The adjusting device 41 can adjust the resistance of the variable resistor according to an operation from the user, thereby changing the resistance of the dimming assembly 40. In the embodiments where the dimming assembly 40 includes the adjusting device 41 and the variable resistor, the variable resistor can be provided through one or more resistors connected in series, in parallel, or in series-parallel to obtain different resistances, thereby providing a variable resistance. In some embodiments, the dimming assembly 40 can be one or more variable resistors.

Furthermore, in some embodiments, the variable resistor can be connected in series, in parallel, or in series-parallel with one or more resistors, thereby setting an adjusting range of the light level from a minimum value to a maximum value.

In some embodiments, the resistor can be integrated with the adjusting device 41, while in other embodiments, the resistor and the adjusting device 41 can be separated parts, which can be set according to actual structures and circuits and is not specifically limited in the present disclosure. When the resistor and the adjusting device 41 are separated parts, the resistor can be arranged on a circuit board in a lamp tube body 11, the adjusting device 41 can be arranged on the lamp tube body 11, a first end cover 12, or a second end cover 13, and the adjusting device 41 is connected with the resistor through wires.

In some embodiments, the dimming assembly 40 includes a sensing unit arranged on the LED light body 10 for sensing environmental information surrounding the LED light and adjusting a resistor thereof according to the environmental information. The sensing unit can be one or more selected from the group consisting of a thermistor, a photosensitive resistor, an acoustic sensitive resistor, a force sensitive resistor, a gas sensitive resistor, a humidity sensitive resistor, and a magnetic resistor. In some embodiments, the environmental information surrounding the LED light includes a current temperature of the LED light, a current light intensity, a current sound, a current pressure, etc. The thermistor can change a resistance thereof according to the current temperature of the LED light, such that the control device 30 adjusts the output current according to the current resistance of the thermistor and thus adjusts the light level of the LED light. The photosensitive resistor can sense the current light intensity surrounding the LED light and change a resistance thereof according to the current light intensity, such that the control device 30 adjusts the output current according to the current resistance of the photosensitive resistor and thus adjusts the light level of the LED light. The acoustic sensitive resistor can sense the current sound intensity surrounding the LED light and change a resistance thereof according to the current sound intensity, such that the control device 30 adjusts the output current according to the current resistance of the acoustic sensitive resistor and thus adjusts the light level of the LED light. The force sensitive resistor can sense the pressing operation from the user and change a resistance thereof according to the pressing operation, such that the control device 30 adjusts the output current according to the current resistance of the force sensitive resistor and thus adjusts the light level of the LED light.

Referring to FIG. 2 to FIG. 4, which is an equivalent schematic view of the dimming assembly 40, the control device 30 includes a control IC. A detecting end of the control IC is connected with the variable resistor and an output end of the control IC is connected with the output unit 50. In some embodiments, the detecting end of the control IC is connected with the sensing unit and the output end of the control IC is connected with the output unit 50.

As shown from FIG. 2 to FIG. 4, RP1 is the variable resistor. In FIG. 2, the control device 30 may include the control IC with a detecting pin (CS) which is the detecting end of the control IC. The detecting pin is electrically connected with the dimming assembly 40 (as shown in FIG. 2); in an embodiment, the detecting pin of the control IC is connected with the variable resistor RP1. When a resistance of the variable resistor RP1 is adjusted by the adjusting device 41, a voltage on the detecting pin of the control IC changes with the resistance of the variable resistor RP1. Therefore, the control IC can obtain the change of the resistance of the variable resistor RP1 by detecting the voltage on the detecting pin thereof and thus adjust the output current according to the voltage on the detecting pin thereof, thereby adjusting the light level of the LED light. In some embodiments, although the control IC is not provided with the dimming function, the LED light can have the dimming function through the dimming circuit disclosed above. The dimming circuit is a hardware design which can quickly and simply adjust the light level of the LED light without requiring the IC to have the dimming function and without using external dimming tools like dimmers, gateways, sensors, or controllers. Also, the dimming function does not need to be realized outside the power supply. The LED light can adjust the light level with a high efficient, a simple circuit structure and a low cost.

In some embodiments, as shown in FIG. 3, the control device 30 may include a dimming IC with a dimming pin (DIM). The dimming pin is electrically connected with the dimming assembly 40. As shown in FIG. 3, the dimming pin is electrically connected with the variable resistor RP1. When the resistance of the variable resistor RP1 is adjusted by a switch, a voltage on the dimming pin of the dimming IC changes with the resistance of the variable resistor RP1. Therefore, the dimming IC can obtain the change of the resistance of the variable resistor by detecting the voltage on the dimming pin and thus adjust the output current according to the voltage on the dimming pin, thereby adjusting the light level of the LED light. The variable resistor may be a pull-up resistor. In some embodiments, although the dimming IC has the dimming function, the light level of the LED light can be adjusted by adjusting the output current according to the change of the resistance of the variable resistor without using the dimming function of the dimming IC and without using software. The dimming circuit is a purely hardware design which can quickly and simply adjust the light level of the LED light without an IC having dimming function and without using external tools like dimmers, gateways, sensors, or controllers. In addition, the dimming function of the LED light does not need to be realized outside the power supply. The LED light can adjust the light level with a high efficient, a simple circuit structure and a low cost.

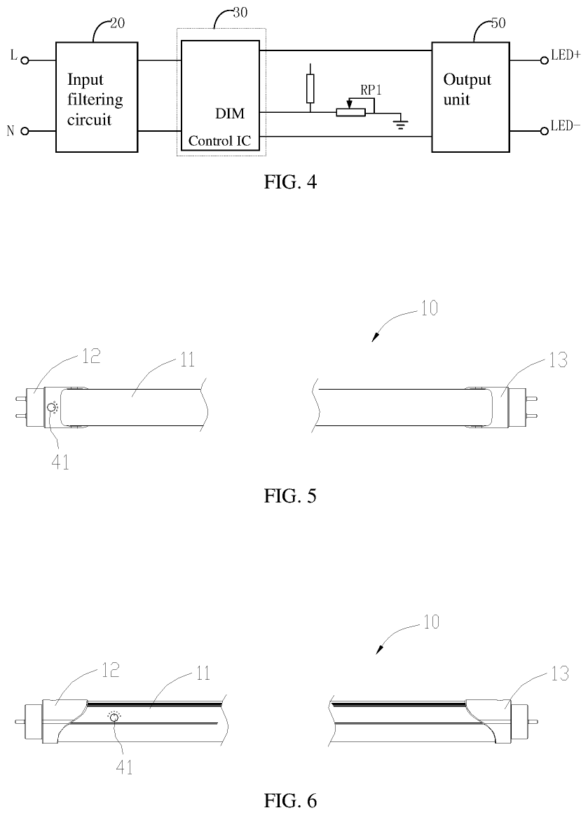

In some embodiments, as shown in FIG. 4, the control device 30 may include a dimming IC with a dimming pin (DIM). The dimming pin is electrically connected with the dimming assembly 40. As shown in FIG. 4, the dimming pin is electrically connected with the variable resistor RP1. When the resistance of the variable resistor RP1 is adjusted by a switch, a voltage on the dimming pin of the dimming IC changes with the resistance of the variable resistor RP1. Therefore, the dimming IC can obtain the change of the resistance of the variable resistor by detecting the voltage on the dimming pin and thus adjust the output current according to the voltage on the dimming pin, thereby adjusting the light level of the LED light. The variable resistor may be a pull-down resistor. In some embodiments, although the dimming IC has the dimming function, the light level of the LED light can be adjusted by adjusting the output current according to the change of the resistance of the variable resistor without using the dimming function of the dimming IC and without using software. The dimming circuit is a purely hardware design which can quickly and simply adjust the light level of the LED light without requiring the IC to have the dimming function and without using external dimming tools like dimmers, gateways, sensors, or controllers. In addition, the dimming function of the LED light does not need to be realized outside the power supply. The LED light can adjust the light level with a high efficient, a simple circuit structure and a low cost.

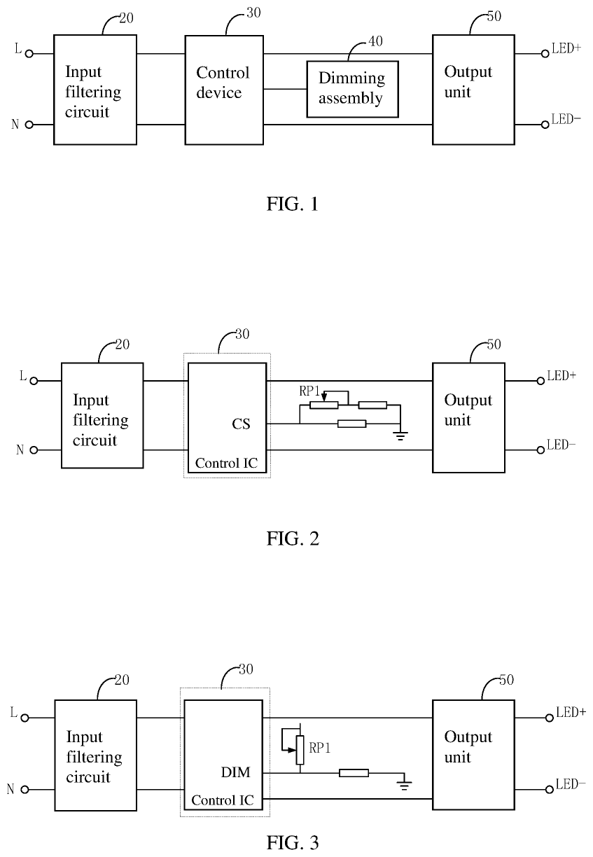

As shown in FIG. 1, in some embodiments, the LED light with dimming function further includes an input filtering circuit 20. The input filtering circuit 20 is arranged between an input end of a voltage signal of the LED light and the control device 30 for receiving the voltage signal from the input end, filtering the voltage signal, and sending the filtered voltage signal to the control device 30. It can be understood that the input filtering circuit 20 can be any filtering circuit applicable in an LED light, which is not limited herein. Furthermore, in an embodiment, the input filtering circuit 20 can filter an AC signal from the input end and send filtered AC signal to the control device 30, thus, interference signals can be removed and the AC signal in the circuit is more stable and more reliable.

Furthermore, in some embodiments, the output unit 50 further includes an output filtering circuit for filtering the signal outputted by the control device 30 for removing interference signals such that a current inputted to the LED light can be more stable and reliable, allowing the LED light to be in a stable work state.

In some embodiments, as shown from FIGS. 5 to 18, the LED light body 10 includes the lamp tube body 11, the first end cover 12 and the second end cover 13. The first end cover 12 and the second end cover 13 are respectively arranged on two ends of the lamp tube body 11. The adjusting device 41 can be arranged on the lamp tube body 11 or arranged on the first end cover 12 or arranged on the second end cover 13. FIGS. 5 to 18 are only used to illustrate the embodiments in which the adjusting device 41 is arranged on the lamp tube body 11 or the first end cover 12, which is not intended to limit the arrangement of the adjusting device 41 of the present disclosure; in other embodiments, the adjusting device 41 can be arranged on the second end cover 13.

In some embodiments, the adjusting device 41 includes one or more selected from a group consisting of a sliding knob, a gear knob, a sliding push button, a gear push button, a dial push button, and a pressed push button.

In some embodiments, as shown in FIG. 5, which is a schematic view of the adjusting device 41 in accordance with an embodiment of the present disclosure, the adjusting device is a gear knob arranged on the first end cover 12. In some embodiments, the gear knob can be arranged on the second end cover 13. As shown in FIG. 5, with the gear knob, the resistance of the variable resistor RP1 can be adjusted, thus, the control device 30 can adjust the output current according to the change of the resistance of the variable resistor RP1, thereby adjusting the light level of the LED light.

In some embodiments, as shown in FIG. 6, which is a schematic view of the adjusting device 41 in accordance with an embodiment of the present disclosure, the adjusting device is a gear knob arranged on the lamp tube body 11. In some embodiments, the gear knob can be arranged on the second end cover 13 or the first end cover 12. As shown in FIG. 6, with the gear knob, the resistance of the variable resistor RP1 can be adjusted, thus, the control device 30 can adjust the output current according to the change of the resistance of the variable resistor RP1, thereby adjusting the light level of the LED light.

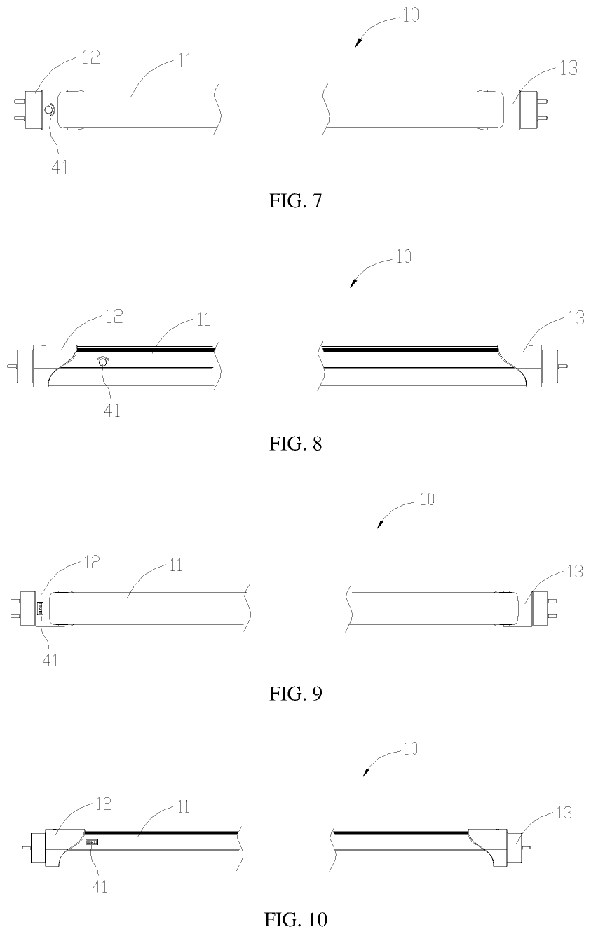

In some embodiments, as shown in FIG. 7, which is a schematic view of the adjusting device 41 in accordance with an embodiment of the present disclosure, the adjusting device is a sliding knob arranged on the first end cover 12. In some embodiments, the sliding knob can be arranged on the second end cover 13 or the lamp tube body 11 of the LED light. As shown in FIG. 7, with the sliding knob, the resistance of the variable resistor RP1 can be adjusted, thus, the control device 30 can adjust the output current according to the change of the resistance of the variable resistor RP1, thereby adjusting the light level of the LED light.

In some embodiments, as shown in FIG. 8, which is a schematic view of the adjusting device 41 in accordance with an embodiment of the present disclosure, the adjusting device is a sliding knob arranged on the lamp tube body 11. In some embodiments, the sliding knob can be arranged on the second end cover 13 or the first end cover 12. As shown in FIG. 8, with the sliding knob, the resistance of the variable resistor RP1 can be adjusted, thus, the control device 30 can adjust the output current according to the change of the resistance of the variable resistor RP1, thereby adjusting the light level of the LED light.

In some embodiments, as shown in FIG. 9, which is a schematic view of the adjusting device 41 in accordance with an embodiment of the present disclosure, the adjusting device is a switch button arranged on the first end cover 12. In some embodiments, the switch button can be arranged on the second end cover 13 or the lamp tube body 11. As shown in FIG. 9, with the witch button, the resistance of the variable resistor RP1 can be adjusted, thus, the control device 30 can adjust the output current according to the change of the resistance of the variable resistor RP1, thereby adjusting the light level of the LED light.

In some embodiments, as shown in FIG. 10, which is a schematic view of the adjusting device 41 in accordance with an embodiment of the present disclosure, the adjusting device is a switch button arranged on the lamp tube body 11. In some embodiments, the switch button can be arranged on the second end cover 13 or the first end cover 12. As shown in FIG. 10, with the switch button, the resistance of the variable resistor RP1 can be adjusted, thus, the control device 30 can adjust the output current according to the change of the resistance of the variable resistor RP1, thereby adjusting the light level of the LED light.

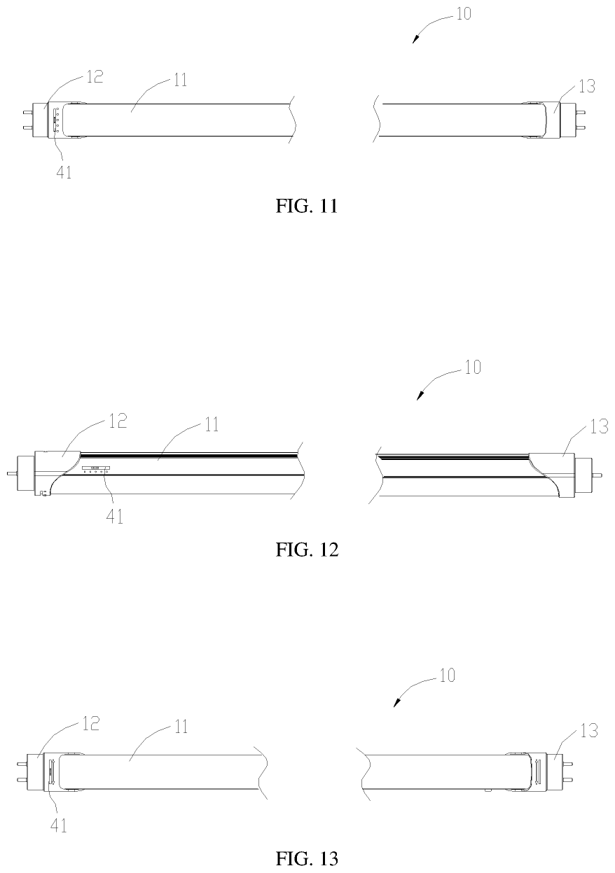

In some embodiments, as shown in FIG. 11, which is a schematic view of the adjusting device 41 in accordance with an embodiment of the present disclosure, the adjusting device is a gear push button arranged on the first end cover 12. In some embodiments, the gear push button can be arranged on the second end cover 13 or the lamp tube body 11. As shown in FIG. 11, with the gear push button, the resistance of the variable resistor RP1 can be adjusted, thus, the control device 30 can adjust the output current according to the change of the resistance of the variable resistor RP1, thereby adjusting the light level of the LED light.

In some embodiments, as shown in FIG. 12, which is a schematic view of the adjusting device 41 in accordance with an embodiment of the present disclosure, the adjusting device is a gear push button arranged on the lamp tube body 11. In some embodiments, the gear push button can be arranged on the second end cover 13 or the first end cover 12. As shown in FIG. 12, with the gear push button, the resistance of the variable resistor RP1 can be adjusted, thus, the control device 30 can adjust the output current according to the change of the resistance of the variable resistor RP1, thereby adjusting the light level of the LED light.

In some embodiments, as shown in FIG. 13, which is a schematic view of the adjusting device 41 in accordance with an embodiment of the present disclosure, the adjusting device is a sliding push button arranged on the first end cover 12. In some embodiments, the sliding push button can be arranged on the second end cover 13 or the lamp tube body 11. As shown in FIG. 13, with the sliding push button, the resistance of the variable resistor RP1 can be adjusted, thus, the control device 30 can adjust the output current according to the change of the resistance of the variable resistor RP1, thereby adjusting the light level of the LED light.

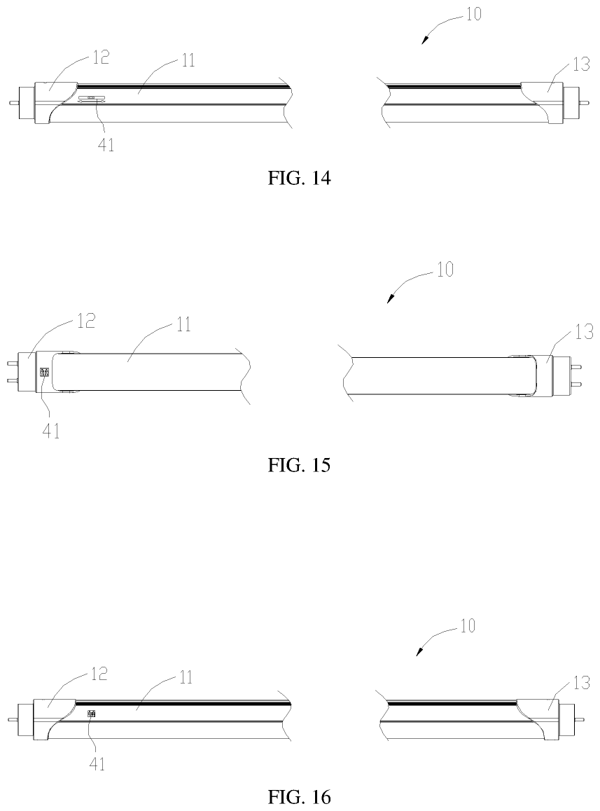

In some embodiments, as shown in FIG. 14, which is a schematic view of the adjusting device 41 in accordance with an embodiment of the present disclosure, the adjusting device is a sliding push button arranged on the lamp tube body 11. In some embodiments, the sliding push button can be arranged on the second end cover 13 or the first end cover 12. As shown in FIG. 14, with the sliding push button, the resistance of the variable resistor RP1 can be adjusted, thus, the control device 30 can adjust the output current according to the change of the resistance of the variable resistor RP1, thereby adjusting the light level of the LED light.

In some embodiments, as shown in FIG. 15, which is a schematic view of the adjusting device 41 in accordance with an embodiment of the present disclosure, the adjusting device is a dial push button arranged on the first end cover 12. In some embodiments, the dial push button can be arranged on the second end cover 13 or the lamp tube body 11. As shown in FIG. 15, with the dial push button, the resistance of the variable resistor RP1 can be adjusted, thus, the control device 30 can adjust the output current according to the change of the resistance of the variable resistor RP1, thereby adjusting the light level of the LED light.

In some embodiments, as shown in FIG. 16, which is a schematic view of the adjusting device 41 in accordance with an embodiment of the present disclosure, the adjusting device is a dial push button arranged on the lamp tube body 11. In some embodiments, the dial push button can be arranged on the second end cover 13 or the first end cover 12. As shown in FIG. 16, with the dial push button, the resistance of the variable resistor RP1 can be adjusted, thus, the control device 30 can adjust the output current according to the change of the resistance of the variable resistor RP1, thereby adjusting the light level of the LED light.

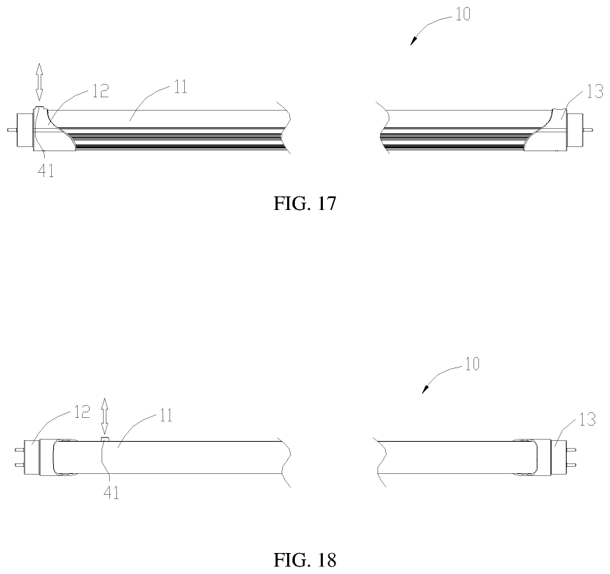

In some embodiments, as shown in FIG. 17, which is a schematic view of the adjusting device 41 in accordance with an embodiment of the present disclosure, the adjusting device is a pressed button arranged on the first end cover 12. In some embodiments, the pressed button can be arranged on the second end cover 13 or the lamp tube body 11. As shown in FIG. 17, with the pressed button, the resistance of the variable resistor RP1 can be adjusted, thus, the control device 30 can adjust the output current according to the change of the resistance of the variable resistor RP1, thereby adjusting the light level of the LED light.

In some embodiments, as shown in FIG. 18, which is a schematic view of the adjusting device 41 in accordance with an embodiment of the present disclosure, the adjusting device is a pressed button arranged on the lamp tube body 11. In some embodiments, the pressed button can be arranged on the second end cover 13 or the first end cover 12. As shown in FIG. 18, with the pressed button, the resistance of the variable resistor RP1 can be adjusted, thus, the control device 30 can adjust the output current according to the change of the resistance of the variable resistor RP1, thereby adjusting the light level of the LED light.

Without changing the wiring of the LED light, the solution of the present disclosure is capable of realizing the dimming function of the LED light according to the change of the resistance of any one of the resistor selected from the group consisting of a thermistor, a photosensitive resistor, an acoustic sensitive resistor, a force sensitive resistor, a gas sensitive resistor, a humidity sensitive resistor, and a magnetic resistor. In addition, the dimming function is realized by a purely hardware design which can quickly and simply adjust the light level of the LED light without requiring the IC to have the dimming function and without using external dimming tools like dimmers, gateways, sensors, or controllers. Thus, the LED light not only can satisfy the requirements of the new standard, but also can automatically adjust the light level in a simple way with a high efficient, a simple structure and a low cost.

The contents described above are only preferred embodiments of the present disclosure, but the scope of the present disclosure is not limited to the embodiments. Any ordinarily skilled in the art would make any modifications or replacements to the embodiments in the scope of the present disclosure, and these modifications or replacements should be included in the scope of the present disclosure. Thus, the scope of the present disclosure should be subjected to the claims.

What is claimed is:

1. A LED light with dimming function, comprising:
a LED light body;
a dimming assembly arranged on the LED light body, the dimming assembly adjusting a resistance thereof according to an adjusting signal and/or an operation;
a control device arranged in the LED light body, the control device being electrically connected with the dimming assembly, detecting the resistance of the dimming assembly, and adjusting an output current according to the resistance of the dimming assembly; and
an output unit connected with the control device, the output unit receiving the output current and sending the output current to the LED light.

2. The LED light with dimming function of claim 1, wherein the dimming assembly comprises a resistor and an adjusting device connected with the resistor; the adjusting device adjusts a resistance of the resistor according to an adjusting signal and/or operation from an user, thereby adjusting the resistance of the dimming assembly.

3. The LED light with dimming function of claim 2, wherein the resistor comprises a variable resistor.

4. The LED light with dimming function of claim 2, wherein the adjusting device comprises one or more selected from a group consisting of a sliding knob, a gear knob, a sliding push button, a gear push button, a dial push button, and a pressed push button.

5. The LED light with dimming function of claim 4, wherein the LED light body comprises a lamp tube body, and the adjusting device is arranged on the lamp tube body.

6. The LED light with dimming function of claim 1, wherein the dimming assembly comprises a sensing unit which is arranged on the LED light body for sensing environmental information surrounding the LED light and adjusting a resistance thereof according to the environmental information.

7. The LED light with dimming function of claim 6, wherein the sensing unit comprises one or more selected from the group consisting of a thermistor, a photosensitive resistor, an acoustic sensitive resistor, a force sensitive resistor, a gas sensitive resistor, a humidity sensitive resistor, and a magnetic resistor.

8. The LED light with dimming function of claim 3, wherein the control device comprises a control IC, a detecting end of the control IC is connected with the variable resistor, an output end of the control IC is connected with the output unit.

9. The LED light with dimming function of claim 1, further comprising an input filtering circuit, wherein the input filtering circuit is arranged between a voltage signal input end of the LED light and the control device for receiving a voltage signal inputted by an input end, filtering the voltage signal, and sending the filtered voltage signal to the control device.

10. The LED light with dimming function of claim 2, wherein the resistor comprises a fixed resistor.

11. The LED light with dimming function of claim 6, wherein the control device comprises a control IC, a detecting end of the control IC is connected with the sensing unit, and an output end of the control IC is connected with the output unit.

12. The LED light with dimming function of claim 4, wherein the LED light body comprises a lamp tube body, a first end cover and a second end cover arranged on two ends of the lamp tube body, and the adjusting device is arranged on the first end cover.

13. The LED light with dimming function of claim 4, wherein the LED light body comprises a lamp tube body, a first end cover and a second end cover arranged on two ends of the lamp tube body, and the adjusting device is arranged on the second end cover.

14. The LED light with dimming function of claim 2, wherein the LED light body comprises a lamp tube body, a first end cover and a second end cover arranged on two ends of the lamp tube body, and the adjusting device is arranged on the first end cover.

15. The LED light with dimming function of claim 2, wherein the LED light body comprises a lamp tube body, a first end cover and a second end cover arranged on two ends of the lamp tube body, and the adjusting device is arranged on the second end cover.
